(19) United States
(12) Patent Application Publication
(10) Pub. No.: US 2021/0007486 A1
(43) Pub. Date: Jan. 14, 2021

(54) DETACHABLE SEATS FOR SHOPPING CARTS

(71) Applicant: Bridgette Smith, Corbin, KY (US)

(72) Inventor: Bridgette Smith, Corbin, KY (US)

(21) Appl. No.: 16/510,963

(22) Filed: Jul. 14, 2019

(51) Int. Cl. A47C 1/00; A47C 3/34; A47C 7/00; B62B 5/00

(52) U.S. Cl. CPC A47C 1/00; A47C 3/34; B62B 3/14; B62B 5/00; A47C 7/006

(57) ABSTRACT

Detachable seats for shopping carts are disclosed. In one example, the detachable seat may include an inverted T shaped an inverted T shaped structure having a vertical hollow portion with an upper end and a horizontal portion. The detachable seat may further include a set of wheels connected to the two ends of the horizontal portion of the inverted T shaped structure. Further, the seat includes a pillar with a seat connected to its upper end, the lower end of the pillar may be inserted to the inverted T shaped structure through the upper end of the vertical hollow portion. Furthermore, lever may be pivotably connected to the pillar just below the seat, wherein the lever may be connected to a shopping cart.

### BACKGROUND

Shopping carts are widely used in supermarkets and hypermarkets all over the world for helping customers to buy products of their choice. Shopping carts have become an integral part of shopping experience all over the world. They are also used in airports, convenience stores, medical stores, and the like. While shopping carts help people easily move around their purchases, most of them are not very user-friendly especially for aged customers and customers with slight disabilities.

Furthermore, many a time, customers would want to check out prices and quality of multiple products that are available for sale and spend plenty of time standing with the cart. It would be helpful for such users if shopping carts come with a temporary arrangement for sitting. At the same time, it is impractical to redesign existing shopping carts which are already available with stores around the world. A huge number of carts will have to be redesigned in such a scenario.

### BRIEF DESCRIPTION OF THE DRAWINGS

Examples are described in the following detailed description and in reference to the drawings, in which:

FIG. 1 is a perspective view of a detachable seat for a shopping cart.

FIG. 2 is a perspective view of a detachable seat for a shopping cart with a shock absorbing lever.

FIG. 3 is a perspective view of a detachable seat for a shopping cart with tripod styled structure and a shock absorbing lever.

FIG. 4 is an example depiction of a detachable seat for a shopping cart described in FIG. 1 connected to the shopping cart.

FIG. 5 is an example depiction of a detachable seat for a shopping cart described in FIG. 3 connected to the shopping cart.

FIG. 6 is an example depiction of a detachable seat for a shopping cart with sensors mounted within the seat.

### DETAILED DESCRIPTION

Shopping carts are universally used in supermarkets across the world for assisting customers in shopping. The design of shopping carts available in the market are very similar across the world and have seen a high amount of adaptability across different countries. While shopping carts help people easily move around with their purchases, most of them are not very user-friendly, especially for aged customers and customers with slight disabilities. Furthermore, many a time, customers would want to check out prices and quality of multiple products that are available for sale and spend plenty of time standing with the cart.

Examples described herein may allow customers shopping with a cart to temporarily rest by sitting on a seat that can be connected to the shopping cart. The examples described herein describes a detachable seat with wheels mounted on its toe end so that the seat may move along with the cart. The detachable seat for shopping cart described herein helps users reduce the strain of standing for a long time by temporarily sitting on the seat, thereby reducing the pressure on their back and legs. Thus, the examples described herein may enhance the reliability and utility of general-purpose shopping carts.

In the following description, for purposes of explanation, numerous specific details are set forth in order to provide a thorough understanding of the present techniques. It will be apparent, however, to one skilled in the art that the present apparatus, devices, and systems may be practiced without these specific details. Reference in the specification to “an example” or similar language means that a particular feature, structure, or characteristic described may be included in at least that one example, but not necessarily in other examples.

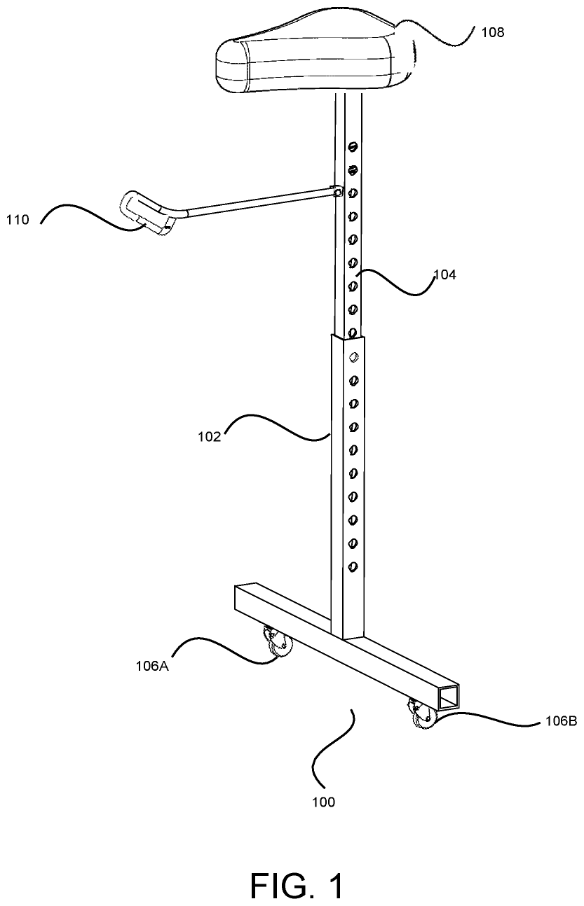

Referring to figures, FIG. 1 is a perspective view of a detachable seat for a shopping cart 100. The detachable seat 100 includes an inverted T shaped structure 102 having a vertical hollow portion with an upper end and a horizontal portion and the bottom end. A set of wheels 106A and 1066 are connected to the two ends of the horizontal portion of the inverted T shaped structure 102 at its bottom portion. Further, the detachable seat 100 may include a pillar 104 with a seat 108 connected to its upper end. The lower end of the pillar may be inserted to the inverted T shaped structure through the upper end of the vertical hollow portion to adjust the height of the seat.

A series of holes are placed through the body of the pillar 104 and the vertical hollow portion of the inverted T shaped structure 102. The holes may be aligned, and a key may be used in such a way that it passes through the holes of both the structures to fix the height of the seat 108. Further, a lever 110 may be pivotably connected to the pillar 104 just below the seat 108. The lever may be connected to any general-purpose shopping cart by using any standard locking mechanism.

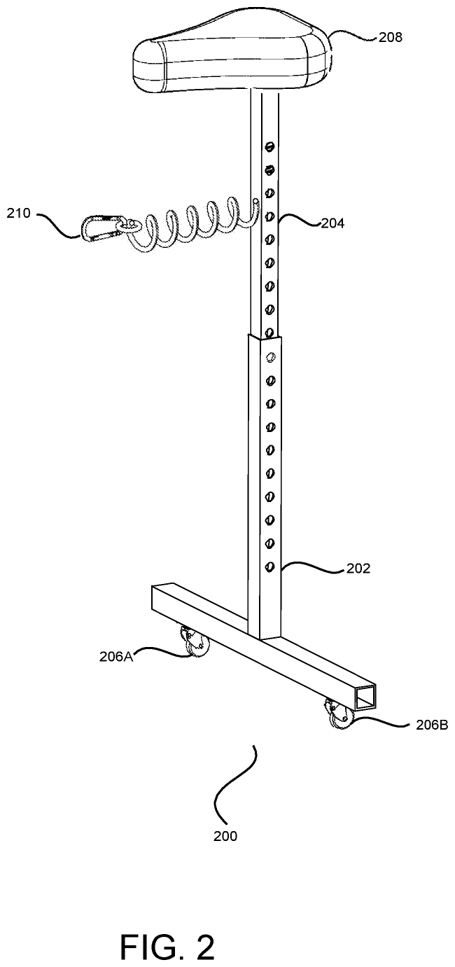

FIG. 2 is a perspective view of a detachable seat for a shopping cart 200 with a shock absorbing lever. The detachable seat 200 includes an inverted T shaped structure 202 having a vertical hollow portion with an upper end and a horizontal portion and the bottom end. A set of wheels 206A and 206B are connected to the two ends of the horizontal portion of the inverted T shaped structure 202 at its bottom portion. Further, the detachable seat 200 may include a pillar 204 with a seat 208 connected to its upper end. The lower end of the pillar may be inserted to the inverted T shaped structure through the upper end of the vertical hollow portion to adjust the height of the seat.

A series of holes are placed through the body of the pillar 204 and the vertical hollow portion of the inverted T shaped structure 202. The holes may be aligned, and a key may be used in such a way that it passes through the holes of both the structures to fix the height of the seat 208. Further, a lever 210 may be pivotably connected to the pillar 204 just below the seat 108. The lever may be connected to any general-purpose shopping cart by using any standard locking mechanism. The lever 210 may be flexible in nature with a spring-like design. The lever 210 may absorb any shock caused by the sudden change in movement caused to the shopping cart thereby allowing the detachable seat 200 to move around smoothly. The lever 210 may act as a shock absorber.

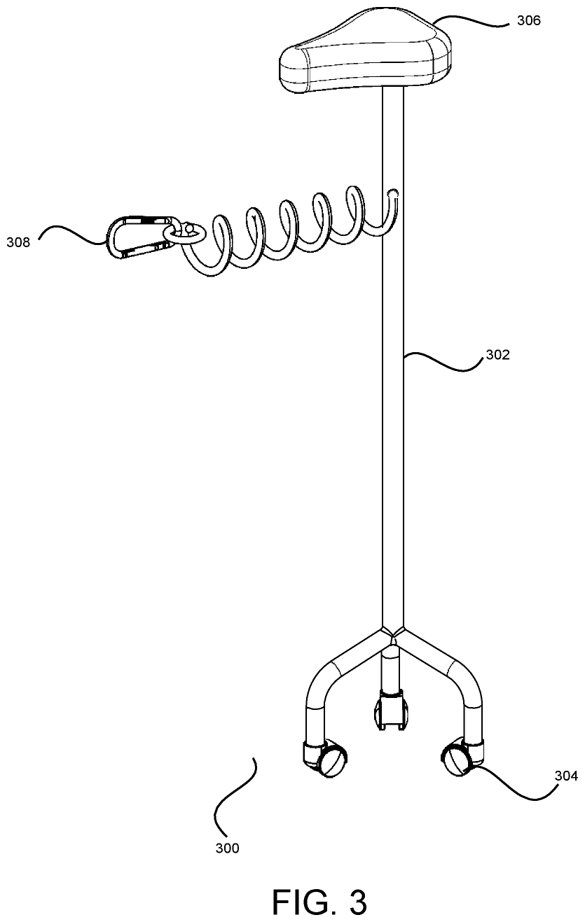

FIG. 3 is a perspective view of a detachable seat for shopping cart 300 with tripod styled structure and a shock absorbing lever The detachable seat 300 may be a tripod shaped structure 302 including a vertical portion with an upper end. The three legs in the lower end of the tripod shaped structure 302 are mounted with wheels 304. A seat 306 may be connected to the upper end of the tripod shaped structure 302. Further, a lever 308 may be pivotably connected to the vertical portion of the tripod shaped structure 302 just below the seat 306. The lever 308 may be connected to a shopping cart using a locking mechanism.

The lever 308 may be flexible in nature with a spring-like design. The level 308 may absorb any shock caused by the sudden change in movement caused to the shopping cart thereby allowing the detachable seat 300 to move around smoothly. The lever 308 may act as a shock absorber in case of any sudden movements to the shopping cart.

The wheels connected to the detachable seats described in FIGS. 1 to 3 may be connected rotatably for allowing the detachable seat to move in any direction. In practical scenarios, the shopping cart may be propelled in any direction during the course of shopping by the customer. A rotatably connected wheel which can move through an angle of 360 degrees in one axis may allow the seat to move in any direction along with the shopping cart. This mechanism may allow smooth movement of the seat in any direction without any glitches.

The first end of the lever 110 of FIG. 1 may be connected to the pillar such that the other end of the level can be moved up and down through an angle of 180 degrees vertically with respect to the first end. This allows free movement of the lever in one axis which may be useful in adapting to shopping carts of different heights, sizes, and designs.

In one example, the lever 110 may be a straight rod. In another example, the lever 210 may be flexible in nature allowing to act as a shock absorber. The flexibility of lever 210 may also allow the lever to be connected to different types of shopping carts with varying heights and form factors.

In an example embodiment, the body of the detachable seat for shopping carts may be made of materials including different grades of steel, aluminium, super magnesium alloy, stainless steel, fibre, hard plastic, and the like. The seat portion of the detachable seats described in FIGS. 1 to 3 may be made of a material which provides high sitting comfort including gels, sponges, foams including memory foams, and the like.

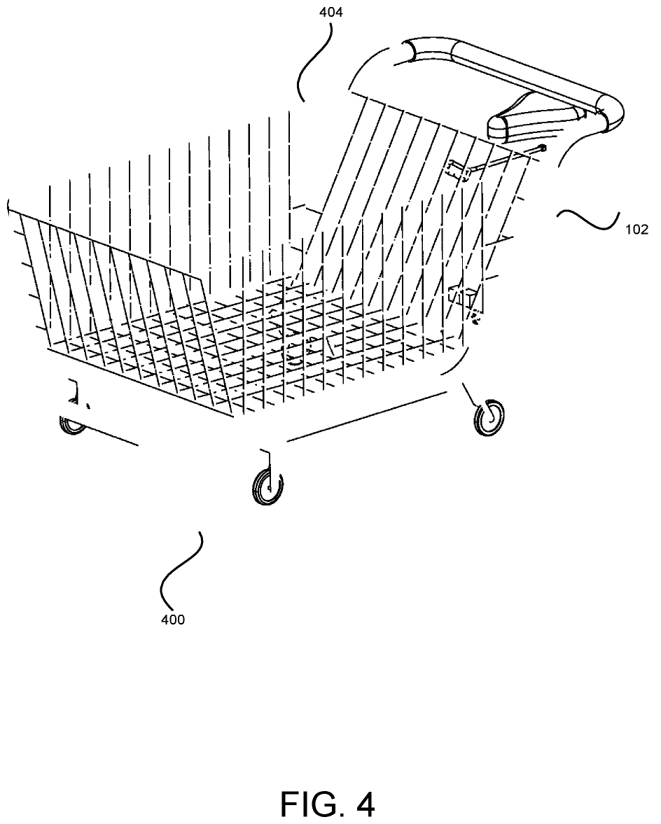

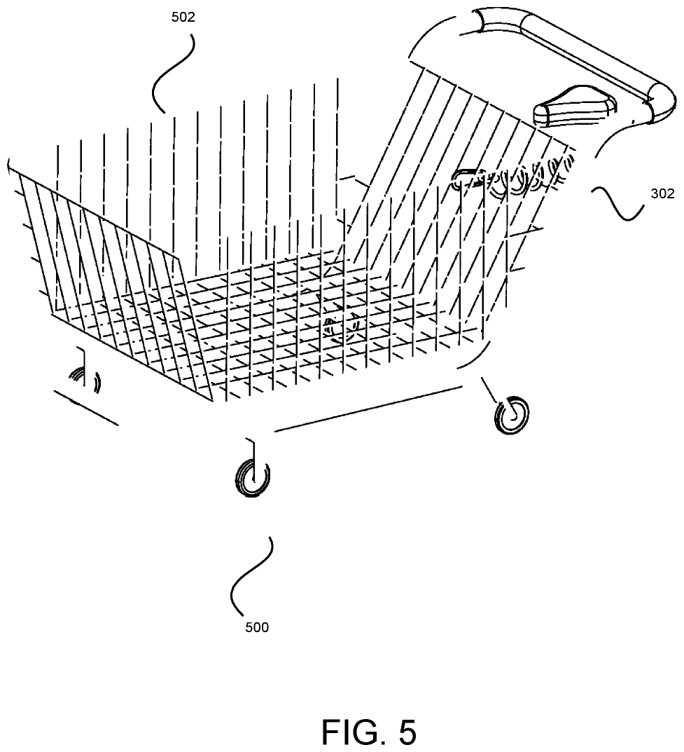

FIG. 4 describes an embodiment of the invention 400 disclosed herein wherein the detachable seat 102 of FIG. 1 is connected to a general-purpose shopping cart. FIG. 5 describes an embodiment of the invention 500 disclosed herein wherein the detachable seat 302 of FIG. 3 is connected to a general-purpose shopping cart. The detachable seats may be adaptable to most of the universally available shopping carts. The levers provided are flexible or movable in nature so that it may be connected to shopping carts of different form factors.

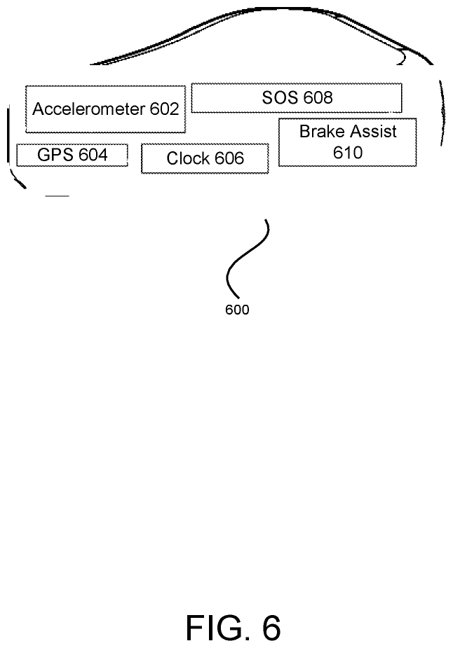

FIG. 6 describes an embodiment of the invention 600 wherein the seat further comprises multiple sensors. The sensors may include an accelerometer sensor 602, a GPS sensor 604, a clock 606, an alarm trigger or SOS sensor 608, and a brake assist sensor 610, and the like.

The detachable seat for shopping cart may focus on individuals with mild mobility challenges to ease and improve their shopping experience in retail stores. This target customers may include individuals with pure mobility challenges and senior citizens. A big advantage of this device is the fact that it will ease the shopping experience for patrons with mobility challenges and will, therefore, increase the revenues for the supermarkets.

In another embodiment, the detachable seat described in FIGS. 1-3 may include a locking mechanism for its wheels. A braking mechanism may be provided to the customer which may be activated manually or configured to activate automatically upon the customer sitting on the seat. The user may manually lock the wheels of the detachable seat so that the detachable seat, as well as the shopping cart attached to it, may remain in a stationary position until the brakes are released by the customer. In another embodiment, the braking mechanism may be activated automatically upon the customer resting on the seat. A sensor for detecting pressure may be mounted into the seat which may activate a set of brakes installed on the wheels upon detecting a pressure greater than a defined threshold.

In yet another embodiment, the detachable seat may include a sensor for detecting the speed at which the cart is propelled. The speed detecting sensors may automatically activate the brakes on the wheels upon crossing a defined speed limit. This mechanism increases the safety aspect of the detachable seat. The shopping cart may move forward or backward by itself on inclined surfaces due to gravitational force. In one example, if the speed of the shopping cart goes beyond a threshold limit, the brakes are initiated automatically. The sensors that detect speed may communicate with the braking mechanism and activate the brakes by locking the wheels of the detachable seat thereby avoiding potential accidents.

In another embodiment, the detachable seat may include a proximity sensor to track any obstructions on the path in which the seat and the cart connected to it is moving. In one example, the wheels may be configured to lock automatically upon detecting an obstruction on the path of the shopping cart. This functionality may allow the customer from accidentally bumping the shopping cart to walls, furniture, people, etc. Furthermore, the detachable seat may be equipped with an alert button programmed to alert specific personnel of the supermarket upon being pressed by the customer. In case the customer faces any difficulty in finding any product or in case of any medical emergency, the assist button may be engaged by the customer to duly alert the storekeeper. The alert button may also function as an emergency or SOS button.

In another example, the emergency assistance is automatically engaged in case the detachable seat or the shopping cart engaged to it detects one of: a sudden change in inertia caused by a crash, increase in speed of the cart and the seat over a particular limit, the detachable seat being moved to unauthorized area or beyond a particular area of the store, and the like. The shopping cart may be equipped with location tracking sensors, accelerometers, a compass, gyro sensors, and the like to detect one of the mentioned events. On detecting such events, an alert is generated and sent to authorized personnel. The alert may be sent as a text message or an email and may comprise information including the logs of all the sensors installed in the detachable seat.

In an illustrative example, if an individual attempts to steal a detachable seat from one of the stores, the device automatically generates an alert upon detecting that its position is not within the defined geographical regions. In such a case, it may send a text message and/or an email alerting the personnel of the store. The message may include location information of the detachable seat and may be automatically updated over time.

In another illustrative example, if a customer hits a wall or if the customer is moving in a speed much higher than a defined threshold limit, an alert is generated. The alert may include the location of the customer retrieved from the location tracking sensor, speed at which the apparatus was traveling from the accelerometer sensor. The detachable seat may be programmed to send alerts to one or more authorized users.

In yet another embodiment, the data received from the sensors may be accumulated and analysed to identify the nature of shopping of the customers. Every detachable seat unit may comprise of a device identity number and may continuously store information received from sensors. By analyzing this data, it can be determined in which section does a customer spend most of his/her time thereby identifying the shopping trends and interests of customers. Using the date and time information along with the abovementioned data, the demand for certain products during certain dates may also be determined.

In one example, it is common knowledge that demand for cakes increases during the Christmas holidays. But there may be many other products whose demands may increase and decrease during certain periods like weekends, holidays, beginning or end of the month, daytime, night-time, summers, winters, etc. These may be accurately determined by using the data accumulated by the location and time sensors.

Examples described herein can also be used in various other scenarios and for various purposes. It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or an appropriate variation thereof. Furthermore, the term “based on,” as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A detachable seat for a shopping cart comprising:
an inverted T shaped structure having a vertical hollow portion with an upper end and a horizontal portion;
a set of wheels connected to the two ends of the horizontal portion of the inverted T shaped structure;
a pillar with a seat connected to its upper end, wherein the lower end of the pillar can be inserted to the inverted T shaped structure through the upper end of the vertical hollow portion to adjust the height of the seat; and
a lever pivotably connected to the pillar below the seat, wherein the lever can be connected to a shopping cart.

2. The detachable seat of claim 1, wherein the set of wheels are rotatably connected to the horizontal portion of the inverted T shaped structure allowing the detachable seat to move in any direction.

3. The detachable seat of claim 1, wherein the first end of the lever is connected to the pillar such that the other end of the level can be moved up and down through an angle of 180 degrees vertically with respect to the first end.

4. The detachable seat of claim 3, wherein the lever is spring shaped and acts as a shock absorber.

5. The detachable seat of claim 3, wherein the lever is a straight rod.

6. The detachable seat of claim 1, wherein the inverted T shaped structure and the pillar is made of steel-based material, fiber-based material, aluminum-based material, or magnesium alloy.

7. The detachable seat of claim 1, wherein the pillar has a series of holes at equal distances and the inverted T shaped structure has one hole near the top end, wherein the holes are used to create a locking mechanism for adjusting the height of the seat.

8. A detachable seat for a shopping cart comprising:
a tripod shaped structure comprising a vertical portion with an upper end and three legs in the lower end;
wheels connected to each of the three legs of the tripod shaped structure;
a seat connected to the upper end of the tripod shaped structure;
and a lever pivotably connected to the vertical portion of the tripod shaped structure below the seat, wherein the lever can be connected to a shopping cart.

9. The detachable seat of claim 8, wherein the set of wheels are rotatably connected to the legs of the tripod shaped structure allowing the detachable seat to move in any direction.

10. The detachable seat of claim 8, wherein the first end of the lever is connected to the pillar such that the other end of the level can be moved up and down through an angle of 180 degrees vertically with respect to the first end.

11. The detachable seat of claim 10, wherein the lever is spring shaped and acts as a shock absorber.

12. The detachable seat of claim 10, wherein the lever is a straight rod.

13. The detachable seat of claim 8, wherein the tripod shaped structure Is made of steel-based material, fiber-based material, aluminum-based material, or magnesium alloy.
